(19) United States
(12) Patent Application Publication
(10) Pub. No.: US 2021/0248674 A1
(43) Pub. Date: Aug. 12, 2021

(54) LEAD GENERATION USING VIRTUAL TOURS

(71) Applicant: Wells Fargo Bank, N.A., San Francisco, CA (US)

(72) Inventor: Uyi Ogunbunmi, Richmond, VA (US)

(21) Appl. No.: 15/369,454

(22) Filed: Dec. 5, 2016

(51) Int. Cl. G06Q 40/02; G06Q 50/16; G06F 3/01; G06T 11/60

(52) U.S. Cl. CPC G06Q 40/025; G06Q 50/16; G06F 3/04815; G06T 11/60; G06F 3/011

(57) ABSTRACT

Techniques are described for generating leads for loan applications for purchase of an asset via a virtual tour of the asset. A customer may visit a website for the asset and activate a virtual tour that includes a sequence of graphical content representing different views of the asset. The techniques of this disclosure determine questions for integration into different portions of the virtual tour of the asset, and determine whether to pre-qualify the customer for a loan for the asset based on user input responsive to the integrated questions. The techniques enable behavioral questions to be posed to the customer as part of the virtual tour experience. The techniques may result in more efficient computing processing, as loan pre-qualification information may be pre-populated in an electronic database of a lending institution such that a customer does not need to enter a different website and/or fill out a traditional loan application.

### TECHNICAL FIELD

This disclosure relates to generating content for display in a virtual tour for an asset.

### BACKGROUND

Individuals seeking to purchase an expensive or “large ticket” asset, such as real property and automobiles or other vehicles, may contact an institution that provides lending services to procure funding for the purchase. Lending institutions provide funds to qualified individual customers to purchase assets using that asset as security for the loan. To initiate the loan origination process, a customer may fill out an extensive loan application and provide the lender with financial information and other personal information, such as social security number, credit information, employment history, financial history, and details about the asset. Alternatively, the lender may offer a preliminary qualification or “pre-qualification” process that requires fewer steps and less information, and that provides the customer with a non-binding indication of a loan amount that the lender would be willing to provide. In addition to requiring fewer steps and less information, a loan pre-qualification is generally not subject to verification and/or underwriting. In this way, the lender may provide a preliminary qualification for a loan for an asset almost instantly.

For example, in the case of real property, a seller may require a pre-qualification letter along with a financing-contingent offer as proof of the customer's ability to procure funds to cover the offered purchase price. A customer may apply for the pre-qualification letter by completing a brief application and/or authorizing the lender to obtain a credit report. The lender uses the customer's credit history and information provided in the brief application, such as the customer's household income, debts, employment history, and available closing funds, to determine whether a customer is preliminarily qualified for a loan and how much the customer is qualified to receive. The customer may then use the pre-qualification letter to make offers on different properties as long as the offered purchase price is within the pre-qualified loan amount.

### SUMMARY

In general, this disclosure describes techniques for generating leads for loan applications for purchase of an asset via a virtual tour of the asset. A customer may visit a website for the asset, e.g., a property, an automobile, or another large ticket item, and activate a virtual tour that includes a sequence of graphical content representing different views of the asset. In the example of the asset being a property, the virtual tour provides the customer (e.g., a potential home buyer) with a guided or self-directed graphical simulation of a physical walkthrough of the property, and may include navigation tools for moving between different portions of the virtual tour, e.g., different views of rooms of the property. The techniques of this disclosure determine questions for integration into different portions of the virtual tour of the asset, and determine whether to pre-qualify the customer for a loan for the asset based on user input responsive to the integrated questions in the virtual tour. The techniques enable behavioral questions to be posed to the customer as part of the virtual tour experience. In this way, the techniques may result in more efficient computing processing, as loan pre-qualification information may be pre-populated in an electronic database of a lending institution such that a customer does not need to enter a different website and/or fill out a traditional loan application.

In one example, this disclosure is directed to a method comprising receiving, by a server computing device, an indication that a user computing device has requested a first portion of a virtual tour associated with a first view of an asset for display to a user, wherein the virtual tour comprises a sequence of graphical content representing different views of the asset; in response to receiving the indication, determining, by the server computing device, a first profile question for integration into the virtual tour based on the first portion of the virtual tour; receiving, by the server computing device and from the user computing device, user input responsive to the first profile question integrated into the virtual tour; generating, by the server computing device, a user profile based on the received user input; and determining, by the server computing device, that the user is preliminarily qualified for a loan for the asset based on the user profile.

In another example, this disclosure is directed to a computing device comprising one or more storage units configured to store user profiles and a plurality of profile questions associated with a virtual tour of an asset, and one or more processors in communication with the storage units. The one or more processors are configured to receive an indication that a user computing device has requested a first portion of the virtual tour associated with a first view of the asset for display to a user, wherein the virtual tour comprises a sequence of graphical content representing different views of the asset; in response to receiving the indication, determine a first profile question for integration into the virtual tour based on the first portion of the virtual tour; receive, from the user computing device, user input responsive to the first profile question integrated into the virtual tour; generate a user profile based on the received user input; and determine that the user is preliminarily qualified for a loan for the asset based on the user profile.

In a further example, this disclosure is directed to a computing device comprising non-transitory computer-readable medium comprising instruction that when executed cause one or more processors to receive, by a server computing device, an indication that a user computing device has requested a first portion of a virtual tour associated with a first view of an asset for display to a user, wherein the virtual tour comprises a sequence of graphical content representing different views of the asset; in response to receiving the indication, determine, by the server computing device, a first profile question for integration into the virtual tour based on the first portion of the virtual tour; receive, by the server computing device and from the user computing device, user input responsive to the first profile question integrated into the virtual tour; generate, by the server computing device, a user profile based on the received user input; and determine, by the server computing device, that the user is preliminarily qualified for a loan for the asset based on the user profile.

The details of one or more examples of this disclosure are set forth in the accompanying drawings and the description below. Other features, objects, and advantages of the disclosure will be apparent from the description and drawings, and from the claims.

### BRIEF DESCRIPTION OF DRAWINGS

FIGS. 1A-1B are block diagrams illustrating example computing devices configured to generate and display a virtual tour for an asset, and generate leads for loan applications for the asset based on the virtual tour, in accordance with one or more techniques of this disclosure.

FIG. 2 is a block diagram illustrating further details of one example of the server computing device shown in FIGS. 1A-AB, in accordance with one or more techniques of the present disclosure.

FIGS. 3A-3B are conceptual diagrams illustrating examples of a graphical user interface including a virtual tour for an asset, in accordance with one or more techniques of this disclosure.

FIG. 4 is a flow diagram illustrating an example operation of computing devices generating leads for loan applications for an asset based on a virtual tour of the asset, in accordance with one or more techniques of this disclosure.

### DETAILED DESCRIPTION

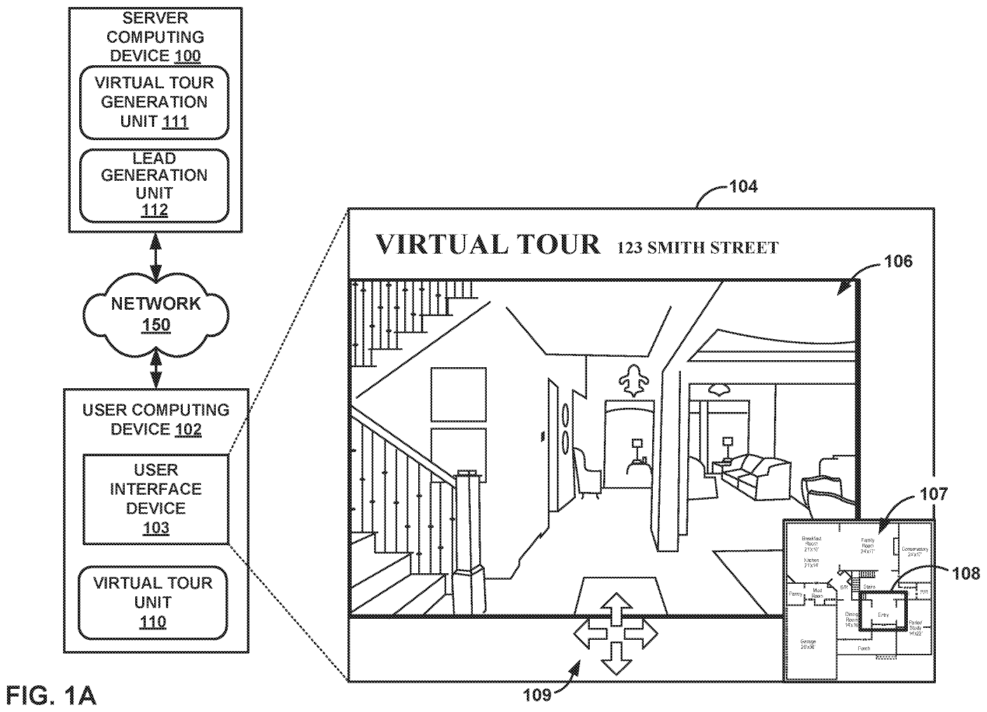

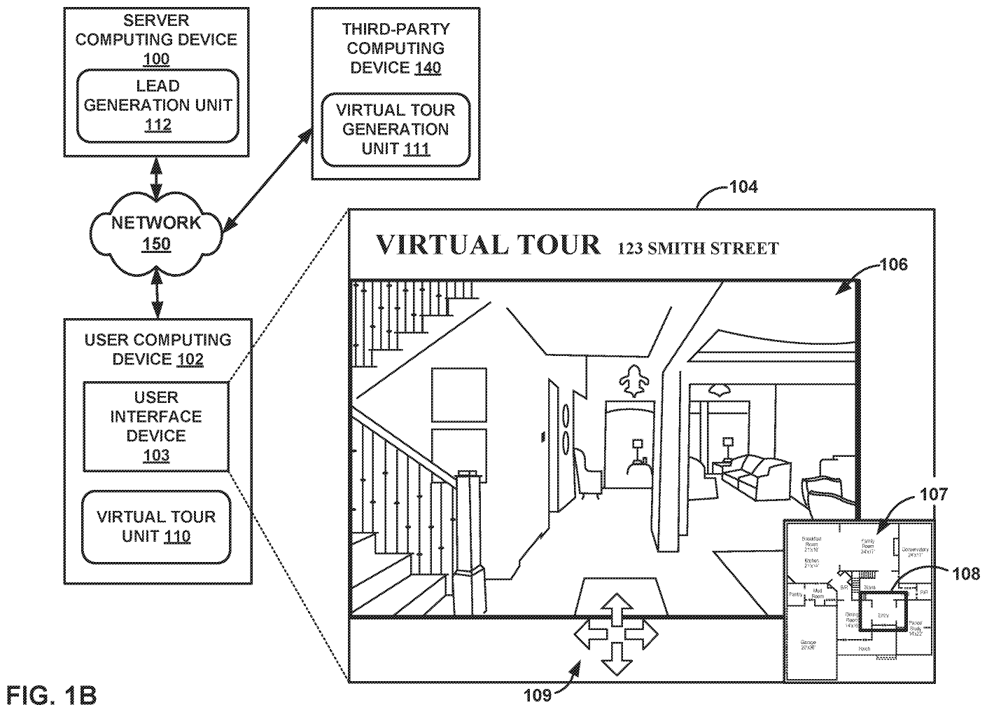

FIGS. 1A-1B are block diagrams illustrating example computing devices that may be used to generate and display a virtual tour for an asset configured to generate leads for loan applications for the asset, in accordance with one or more techniques of this disclosure.

Traditionally, to initiate a loan origination process for the purchase of an expensive or “large ticket” asset, e.g., real property and automobiles or other vehicles, a customer may fill out an extensive loan application with a lending institution. As part of the application, the customer provides the lender with financial information and other personal information, such as social security number, credit information, employment history, financial history, and details about the asset to be purchased. Alternatively, the lender may offer a preliminary qualification or “pre-qualification” process that requires fewer steps and less information. The loan pre-qualification provides the customer with a non-binding indication of a loan amount that the lender would be willing to provide. In addition to requiring fewer steps and less information, the loan pre-qualification is generally not subject to verification and/or underwriting. In this way, the lender may provide a preliminary qualification for a loan for an asset almost instantly.

Online shopping for large ticket items has increased through the use of detailed photographs and virtual tours. For example, customers may conduct property searches without leaving their home using websites and applications that provide comprehensive data about a property, as well as graphical views of the property. However, online shopping for large ticket items has also changed the loan application processes. Conventionally, a lender may solicit and originate loan applications based on face-to-face interactions with a customer physically present either at a prospective property or in the lender's office. Some approaches, such as embedding a loan origination link within a webpage for an asset that directs a customer to a loan application form on a different website, can easily be disregarded by the customer and have provided poor results in terms of lead generation for loan applications.

The techniques described in this disclosure generate leads for loan applications for purchase of an asset via a virtual tour of the asset. A customer may visit a website for the asset and activate a virtual tour that includes a sequence of graphical content representing different views of the asset. In the example of the asset being a property, the virtual tour provides the customer (e.g., a potential home buyer) with a guided or self-directed graphical simulation of a physical walkthrough of the property, and may include navigation tools for moving between different portions of the virtual tour, e.g., different views of rooms of the property. The techniques of this disclosure determine questions for integration into different portions of the virtual tour of the asset, and determine whether to pre-qualify the customer for a loan for the asset based on user input responsive to the integrated questions in the virtual tour. The techniques enable behavioral questions to be posed to the customer as part of the virtual tour experience. In this way, the techniques may result in more efficient computing processing, as loan pre-qualification information may be pre-populated in an electronic database of a lending institution such that a customer does not need to enter a different website and/or fill out a traditional loan application.

FIG. 1A is a block diagram illustrating an example server computing device 100 configured to generate a virtual tour for an asset, and generate lead information for a loan for the asset based on user interaction with the virtual tour via user computing device 102. In the illustrated example of FIG. 1A, server computing device 100 includes a virtual tour generation unit 111 and a lead generation unit 112, and interacts with a user computing device 102 via a computer network 150. User computing device 102 includes a user interface (UI) device 103 and a virtual tour unit 110. In other examples, computing devices 100, 102 may include additional components not shown in FIG. 1A.

Virtual tour generation unit 111 of server computing device 100 is configured to generate a virtual tour for an asset (e.g., a property, an automobile, or another large ticket item) that includes a sequence of graphical content representing different views of the asset. Virtual tour unit 111 of user computing device 102 is configured to request a portion of the virtual tour associated with one of the views of the asset, and output the portion of the virtual tour to a user or customer via UI device 103 of user computing device 102.

In accordance with techniques of this disclosure, lead generation unit 112 of server computing device 100 is configured to determine profile questions for integration into different portions of the virtual tour for the asset, e.g., as generated by virtual tour generation unit 111. Lead generation unit 112 may select a profile question based on the portion of the virtual tour requested for display to a customer. In other words, lead generation unit 112 of server computing device 100 may generate profile questions based on a “view” of the asset or a “location” of the customer within the virtual tour. The profile questions may be behavioral questions posed to the customer as part of the virtual tour experience that are used to gather loan pre-qualification information on the customer. Based on user input to UI device 103 of user computing device 102 responsive to the integrated questions in the virtual tour, lead generation unit 112 of server computing device 100 is configured to determine whether to preliminarily qualify the customer for a loan for the asset.

Examples of computing device 100, 102 may include one or more desktop computers, servers, mainframes, tablet computers, smart television platforms, portable or mobile devices, such as mobile phones (including smart phones), etc. Server computing device 100 may be a server or a wired computing device coupled to a server configured to store virtual tour content for one or more assets, a plurality of profile questions, and a plurality of user profiles. In some examples, server computing device 100 may be associated with a lending institution, such as a bank or a credit union. User computing device 102 may comprise a mobile computing device, such as a smart phone or smart pad, or a laptop or personal computer, operated by a user that is a potential customer of the lending institution. Server computing device 100 and user computing device 102 may communicate via network 150. Network 150 may comprise a private network including, for example, a private network associated with an organization, or may comprise a public network, such as the Internet. Although illustrated in FIG. 1A as a single entity, in other examples network 150 may comprise a combination of public and/or private networks.

In accordance with the disclosed techniques, server computing device 100 includes lead generation unit 112 configured to generate a plurality of profile questions to be integrated into a virtual tour. Lead generation unit 112 may provide the profile questions for the virtual tour in response to various requests, such as in response to receiving indications that user computing device 102 has requested portions of a virtual tour of an asset for display. In one example, lead generation unit 112 may transmit the one or more profile questions for integration into the virtual tour virtual tour to virtual tour unit 110 of user computing device 102. In another example, lead generation unit 112 may transmit the one or more profile questions to virtual tour generation unit 111 within server computing device 100 for integration into the virtual tour.

Lead generation unit 112 may be implemented in various ways. For example, as illustrated in FIG. 1A, lead generation unit 112 may be implemented as a software unit executing on server computing device 100 along with virtual tour generation unit 111. In another example, as illustrated in FIG. 1B, lead generation unit 112 may be implemented as a software unit executing on server computing device 100, and a virtual tour generation unit 111 may be implemented as a software unit executing on a third-party computing device. In either example, lead generation unit 112 may include functionality exposed as one or more application programming interfaces (APIs) to an administrator, virtual tour generation unit 111, or virtual tour unit 110.

Virtual tour unit 110 of user computing device 102 is configured to request, process and output a virtual tour of an asset to a customer via UI device 103. In some examples, UI device 103 of user computing device 102 may be configured to output tactile, audio, or visual content, and/or receive tactile, audio, or visual input. For example, UI device 103 may include a display and one or more input devices, such as a mouse and keyboard. In other examples, UI device 103 may include a touch-sensitive and/or presence-sensitive display or any other type of device for receiving input. In some examples, UI device 103 may display a graphical user interface (GUI) 104 for a virtual tour of an asset through which a customer may interact with the virtual tour.

The virtual tour may include a sequence of graphical content that represents different views of the asset. For example, virtual tour unit 110 may request different portions of the virtual tour associated with different views of the asset for display to the user via UI device 103. In this way, virtual tour unit 110 may simulate a physical walkthrough of the property by the user. In some examples, the virtual tour may be a guided tour that includes graphical content arranged in a pre-determined or suggested sequence. In some examples, the virtual tour may be an interactive tour that includes graphical content that may be navigated in response to user input. Although primarily described in this disclosure as being a sequence of still images, in other examples the graphical content may include videos, animated graphics, panoramas, 3D graphical content, virtual reality (VR) content, and the like. In some examples, the virtual tour may comprise an augmented reality (AR) tour that includes a live or real-time video feed of the asset with graphical content overlaying the video feed to provide additional information to the user.

Virtual tour unit 110 may be implemented in various ways. For example, virtual tour unit 110 may be implemented as a downloadable or pre-installed application or “app” on user computing device 102 configured to retrieve virtual tour content from another computing device (e.g., computing device 100). The retrieved virtual tour content may be rendered for display either by virtual tour unit 110 or by another application, such as a web browser application, on user computing device 102.

Virtual tour unit 110 is configured to generate GUI 104 for display of a virtual tour via UI device 103. GUI 104 may include graphical content, including text, images, a group of moving images, or the like. In some examples, GUI 104 may display one or more detailed views 106 of an asset, such as views of different rooms within a property. A detailed view 106 of a virtual tour of a property may include graphical content depicting a portion of the property from the perspective of a particular location within the property. That is, the virtual tour of the property may include graphical content that simulates the experience of a user viewing the property in-person. In some examples, GUI 104 may include a map 107 providing an overview of the asset. For example, as shown in FIG. 1A, GUI 104 includes a view 106 of an entry or foyer area of a property, and a map 107 depicting a floorplan of the property. In some examples, GUI 104 may also include a view indicator 108 that indicates a location within map 107 of current view 106. As shown in FIG. 1A, view indicator 108 is a rectangle shape overlaid on a portion of map 107 corresponding to a foyer area of the property's floorplan to represent that the current view 106 is of the entry or foyer area of the property.

Virtual tour unit 110 may be configured to modify GUI 104 to output a different view 106 of the asset in response to user input. GUI 104 may include one or more user interface elements (e.g., buttons) that enable a user to navigate between various portions of the virtual tour associated with different views of the asset. In the illustrated example of FIG. 1A, GUI 104 may include one or more navigation keys 109, which, in response to user input, change the displayed view 106 to a different view of the asset. Navigation keys 109 may include a plurality of keys corresponding to a direction of movement (e.g., “forward”, “backward”, “left”, “right”, etc.), a sequential direction (e.g., “next”, “previous”, “first”, “last”, etc.), a pre-determined labeled view (e.g., “family room”, “kitchen”, “garage”, etc.), and the like. In one example, virtual tour unit 110 may receive user input from a navigation key 109 (e.g., “forward”) and, in response, modify GUI 104 to display a new view that is positioned in the virtual tour in a forward direction relative to the current view 106. In some examples, portions of view 106 may be configured to directly receive user input indicating navigation to a different view from the perspective of view 106 that receives the user input. For example, virtual tour unit 110 may receive user input from a portion of view 106 depicting a hallway and, in response, modify GUI 104 to display a new view from the perspective of a person standing in the hallway.

In the example illustrated in FIG. 1A, virtual tour unit 110 may retrieve the virtual tour content from virtual tour generation unit 111 executing on server computing device 100. For example, virtual tour unit 110 may request particular portions of a virtual tour (e.g., in response to navigation keys 109) from virtual tour generation unit 111, and in turn, virtual tour generation unit 111 of server computing device 100 may transmit the requested portions of the virtual tour to virtual tour unit 110 of user computing device 102 for display.

In accordance with the disclosed techniques, virtual tour unit 110 is configured to also receive one or more profile questions associated with the requested portions of the virtual tour. In one example, virtual tour unit 110 of user computing device 102 may receive the one or more profile questions directly from lead generation unit 112 of server computing device 100. In this example, virtual tour unit 110 may overlay the one or more profile questions onto corresponding views of the virtual tour. In another example, virtual tour unit 110 of user computing device 102 may receive the one or more profile questions already integrated into portions of the virtual tour from virtual tour generation unit 111 of server computing device 100.

Virtual tour unit 110 may receive user input via user interface device 103 in response to the one or more profile questions integrated into the virtual tour of the asset and, in turn, transmit the user input to lead generation unit 112 of server computing device 100. As described in greater detail below, lead generation unit 112 generates a user profile based on the received user input, and determines whether the user is preliminarily qualified for a loan for the asset based on the user profile. Virtual tour unit 110 may then receive, from lead generation unit 112, an indication whether the user is prequalified for the loan for the asset. Virtual tour unit 110 may modify GUI 104 to include the indication of loan pre-qualification for the user. The displayed indication may include a request from the lending institution to collect additional sensitive information, e.g., social security number, credit information, and financial history, from the user to complete processing of the loan.

While some examples of the present disclosure describe in detail a virtual tour of a residential property, the described techniques may be applied to other types of properties, such as apartments, condominiums, commercial property, as well as other types of assets, such as motor vehicles, boats, and the like. For example, lead generation unit 112 may determine profile questions for integration into a virtual tour of a motor vehicle having multiple views of the motor vehicle (e.g., interior, exterior, left side, and right side).

FIG. 1B is a block diagram illustrating an example third-party computing device 140 configured to generate a virtual tour for an asset, and an example of server computing device 100 configured to generate lead information for a loan for the asset based on user interaction with the virtual tour via user computing device 102. In the illustrated example of FIG. 1B, third-party computing device 140 includes virtual tour generation unit 111, server computing device 100 includes a lead generation unit 112, and user computing device 102 includes UI device 103 and virtual tour unit 110. Third-party computing device 140, server computing device 100, and user computing device 110 communicate via computer network 150. In other examples, computing devices 100, 102, and 140 may include additional components not shown in FIG. 1B.

The computing system depicted in FIG. 1B is similar to the system depicted in FIG. 1A except, in the system of FIG. 1B, lead generation unit 112 is implemented as a software unit executing on server computing device 100, and virtual tour generation unit 111 is implemented as a software unit executing on third-party computing device 140. As an example, third-party computing device 140 and the virtual tour content may be managed by an organization that provides real estate listings and virtual tours to users, while server computing device 100 may be managed by the lending institution. Examples of third-party computing device may include one or more desktop computers, servers, mainframes, tablet computers, smart television platforms, portable or mobile devices, such as mobile phones (including smart phones), etc.

In accordance with the disclosed techniques, server computing device 100 includes lead generation unit 112 configured to generate a plurality of profile questions to be integrated into a virtual tour. Lead generation unit 112 may provide the profile questions for the virtual tour in response to various requests, such as in response to receiving indications that user computing device 102 has requested portions of a virtual tour of an asset for display. In one example, lead generation unit 112 may transmit the one or more profile questions for integration into the virtual tour virtual tour to virtual tour unit 110 of user computing device 102. In another example, lead generation unit 112 may transmit the one or more profile questions to virtual tour generation unit 111 within third-party computing device 140 for integration into the virtual tour.

In the example illustrated in FIG. 1B, virtual tour unit 110 may retrieve the virtual tour content from virtual tour generation unit 111 executing on third-party computing device 140. For example, virtual tour unit 110 may request particular portions of a virtual tour (e.g., in response to navigation keys 109) from virtual tour generation unit 111, and in turn, virtual tour generation unit 111 of third-party computing device 100 may transmit the requested portions of the virtual tour to virtual tour unit 110 of user computing device 102 for display.

In accordance with the disclosed techniques, virtual tour unit 110 is configured to also receive one or more profile questions associated with the requested portions of the virtual tour. In one example, virtual tour unit 110 of user computing device 102 may receive the one or more profile questions directly from lead generation unit 112 of server computing device 100. In this example, virtual tour unit 110 may overlay the one or more profile questions onto corresponding views of the virtual tour content received from virtual tour generation unit 111 of third-party computing device 140. In another example, virtual tour unit 110 of user computing device 102 may receive the one or more profile questions already integrated into portions of the virtual tour from virtual tour generation unit 111 of third-party computing device 140.

As described above with the respect to FIG. 1A, virtual tour unit 110 may receive user input via user interface device 103 in response to the one or more profile questions integrated into the virtual tour of the asset and, in turn, transmit the user input to lead generation unit 112 of server computing device 100. Lead generation unit 112 generates a user profile based on the received user input, and determines whether the user is preliminarily qualified for a loan for the asset based on the user profile. Virtual tour unit 110 may then receive, from lead generation unit 112, an indication whether the user is prequalified for the loan for the asset. Virtual tour unit 110 may modify GUI 104 to include the indication of loan pre-qualification for the user.

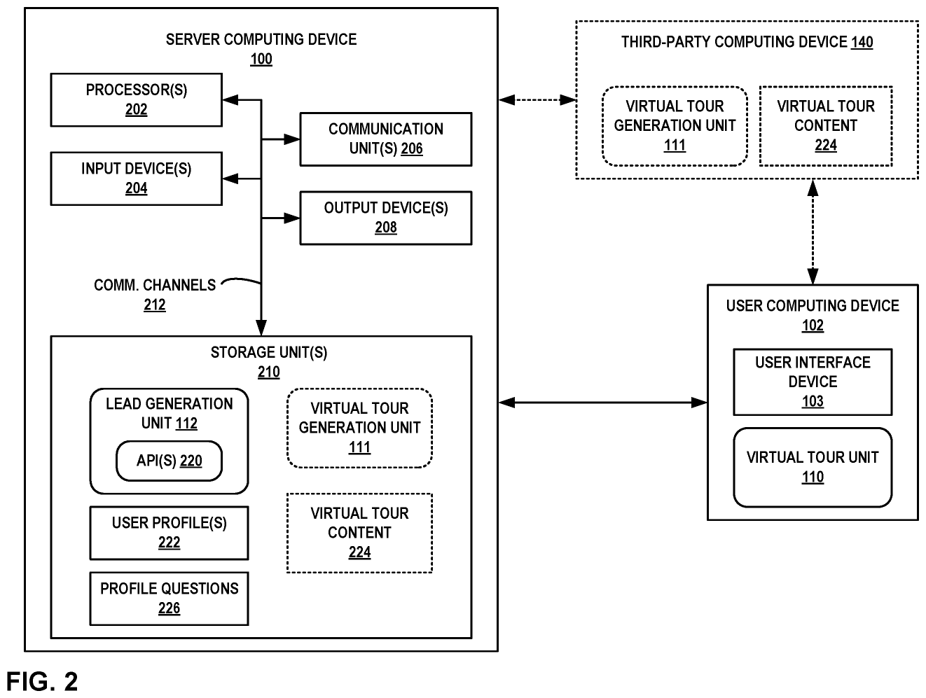

FIG. 2 is a block diagram illustrating further details of one example of server computing device 100 shown in FIGS. 1A-1B, in accordance with one or more techniques of this disclosure. FIG. 2 illustrates only one particular example of computing device 100 as shown in FIGS. 1A-1B, and many other examples of computing device 100 may be used in other instances.

As shown in the specific example of FIG. 2, server computing device 100 includes one or more processors 202, one or more input devices 204, one or more communication units 206, one or more output devices 208, and one or more storage units 210. As described above with respect to FIGS. 1A-1B, server computing device 100 includes lead generation unit 112 and virtual tour generation unit 111 that are executable by computing device 100 (e.g., by one or more processors 202). In the example illustrated in FIG. 2, sever computing device 100 further includes user profiles 222, virtual tour content 224, and profile questions 226.

Each of components 202, 204, 206, 208, and 210 may be interconnected (physically, communicatively, and/or operatively) by communication channels 212 for inter-component communications. In some examples, communication channels 212 may include a system bus, a network connection, an inter-process communication data structure, or any other method for communicating data. Lead generation unit 112 and virtual tour generation unit 111 may also communicate information with one another as well as with components 202, 204, 206, and 208, and data stores within storage units 210 including profile questions 226, user profiles 222, and virtual tour content 224.

Processors 202, in one example, are configured to implement functionality and/or process instructions for execution within server computing device 100. For example, processors 202 may be capable of processing instructions stored in storage units 210. Examples of processors 202 may include any one or more of a microprocessor, a controller, a digital signal processor (DSP), an application specific integrated circuit (ASIC), a field-programmable gate array (FPGA), or equivalent discrete or integrated logic circuitry.

Storage units 210 may be configured to store information within computing device 100 during operation. In some examples, storage units 210 may be described computer-readable storage media. Storage units 210 may store program instructions for execution by processors 202. Storage units 210, in one example, are used by software or applications running on server computing device 100 (e.g., lead generation unit 112 and/or virtual tour generation unit 111) to temporarily store information during program execution.

Storage units 210 may include one or both of long-term memory and temporary memory. Storage units 210, in some examples, may comprise volatile memory, meaning that storage units 210 do not maintain stored contents when the computer is turned off. Examples of volatile memories include random access memories (RAM), dynamic random access memories (DRAM), static random access memories (SRAM), and other forms of volatile memories known in the art. In other examples, storage units 210 may be configured to store larger amounts of information than volatile memory. Storage units 210 may include non-volatile memory. Examples of such non-volatile memory include magnetic hard discs, optical discs, floppy discs, flash memories, or forms of electrically programmable memories (EPROM) or electrically erasable and programmable (EEPROM) memories.

Server computing device 100 may utilize communication units 206 to communicate with external devices via one or more networks, such as one or more wireless networks. Communication units 206 may comprise network interface cards, such as an Ethernet cards, optical transceivers, radio frequency transceivers, or any other type of device that can send and receive information. Other examples of such network interfaces may include Bluetooth, 3G, and WiFi radios as well as Universal Serial Bus (USB) interfaces. In some examples, server computing device 100 utilizes communication units 206 to wirelessly communicate with an external device such as user computing device 102 or third-party computing device 140.

Input devices 204 and output devices 208, in some examples, are configured to receive input from a user and provide output to a user using tactile, audio, or video feedback. Examples of input devices 204 include a presence-sensitive input device (e.g., a presence-sensitive display), mouse, keyboard, voice responsive system, video camera, microphone, or any other type of device for detecting a command from a user. Examples of output devices 208 include a presence-sensitive display, sound card, video graphics adapter card, or any other type of device for converting a signal into an appropriate form understandable to humans or machines. Additional examples of output device 208 include a speaker, cathode ray tube (CRT) monitor, liquid crystal display (LCD), or any other type of device that can generate intelligible output to a user.

In other examples, server computing device 100 may include additional components that are not shown in FIG. 2. For example, server computing device 100 may include a power supply to provide power to the components of server computing device 100. Similarly, the components of server computing device 100 shown in FIG. 2 may not be necessary in every example of server computing device 100. For example, in some configurations, server computing device 100 may not include input devices 204 and output devices 208.

In accordance with techniques of the present disclosure, server computing device 100 is configured to store a plurality of virtual tour content 224 in storage units 210. Virtual tour content 224 may include graphical content that graphically depicts an asset in a variety of views. Virtual tour content 224 may be stored and indexed using one or more identifiers that can be used to retrieve content for a particular property (e.g., according to a unique property identifier) or for a particular portion of the property (e.g., according to a coordinate system). While FIGS. 1A and 1B depict examples of a virtual tour comprised of graphics and still images, examples configured according to the present disclosure may include various types of graphical content, including videos, animated graphics, panoramas, 3D graphical content, virtual reality (VR) content, and the like. In some examples, the virtual tour may comprise an augmented reality (AR) tour that includes a live or real-time video feed of the asset with graphical content overlaying the video feed to provide additional information to the user.

Server computing device 100 is configured to store a plurality of profile questions 226 in storage units 210. The profile questions 226 may be behavioral questions that are used to gather loan pre-qualification information on the customer. The profile questions 226 may be generated to inquire a customer for information that is related to the property but also that can be used to infer personal information about the customer. For example, a profile question 226 can inquire about a customer's marital status or number of dependents (e.g., “Would this extra room be used for an office or for the kids?”). In another example, a profile question 226 can inquire about a customer's employment status and history (e.g., “Do you have a job in the area?”, “Is your job an easy commute from here?”). In another example, a profile question 226 can inquire about a customer's assets (e.g., “Will this garage fit all the cars you have?”).

In some examples, server computing device 100 may be configured to generate a mapping between the plurality of profile questions 226 and a plurality of different views of assets. For example, lead generation unit 112 may encode a “garage” view type to one or more profile questions 226 that would be appropriate to ask the user that is viewing a garage portion of a property, such as “Will this garage fit all the cars you have?”. In some examples, lead generation unit 112 may further associate profile questions 226 with a property type (e.g., apartment, house) or even to a particular property unit (e.g., as identified by a property ID).

Lead generation unit 112 may be configured to generate a user profile 222 based on the user's responses to the profile questions. For example, user profile 222 may be an entry in an electronic database of the lending institution, and lead generation unit 112 may populate the entry with loan pre-qualification information gathered on the customer based on the user's responses to the profile questions. As used herein, generating a user profile may refer to the creation of a new user profile as well as the modification and updating of an existing user profile. In some examples, a user profile 222 linked to a user may be configured to persist across multiple virtual tours initiated by that user. In other examples, a user profile 222 may be a temporary instance generated for a user session that is defined by the beginning of a virtual tour and the end of the same virtual tour.

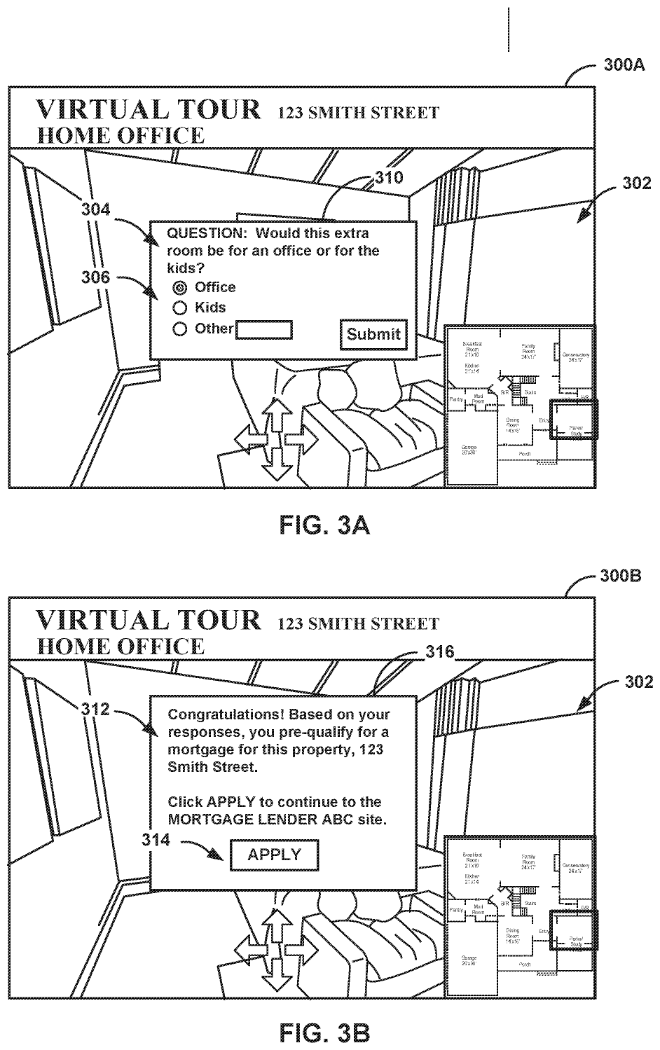

FIGS. 3A-3B are conceptual diagrams illustrating examples of a graphical user interface (GUI) including a virtual tour for an asset, in accordance with one or more techniques of this disclosure. In the examples of FIGS. 3A-3B, the asset is described as a property, e.g., 123 Smith Street. In other examples, the illustrated GUI may include a virtual tour for another type of “large ticket” item for which a loan may be procured, such as a vehicle.

For example, as illustrated in FIG. 3A, a GUI 300A includes a view 302 of a room designated as a “home office.” GUI 300A also includes a text box 310 that is integrated into view 302 and comprises a profile question 304 (e.g., “Would this extra room be used for an office or for the kids”) and one or more response options 306 (e.g., “office”, “kids”, “other”). In some examples, text box 310 is rendered as an overlay of view 302, e.g., on top of a picture of the home office depicted in view 302. In other examples, text box 310 may be rendered as a sidebar portion of GUI 300A or otherwise positioned around view 302.

As illustrated in FIG. 3B, GUI 300B includes another text box 316 that integrated into view 302 and comprises an indication 312 that the user undergoing the virtual tour of the property has pre-qualified for a mortgage loan for the property (e.g., “Congratulations! Based on your responses, you pre-qualify for a mortgage for this property, 123 Smith Street.”). In some examples, GUI 300B may include a call-to-action button, link, or other user interface element 314 configured to, in response to user interaction, re-direct the user to a different website or allow the lending institution to contact the user in order to collect additional sensitive information, e.g., social security number, credit information, and financial history, to complete processing of the loan. For example, as shown in FIG. 3B, virtual tour unit 110 outputs text box 316 including an “Apply” button 314 configured to open a website provided by the lender (e.g., “Mortgage Lender ABC site”) for the user to provide contact information and/or complete a more detailed loan application.

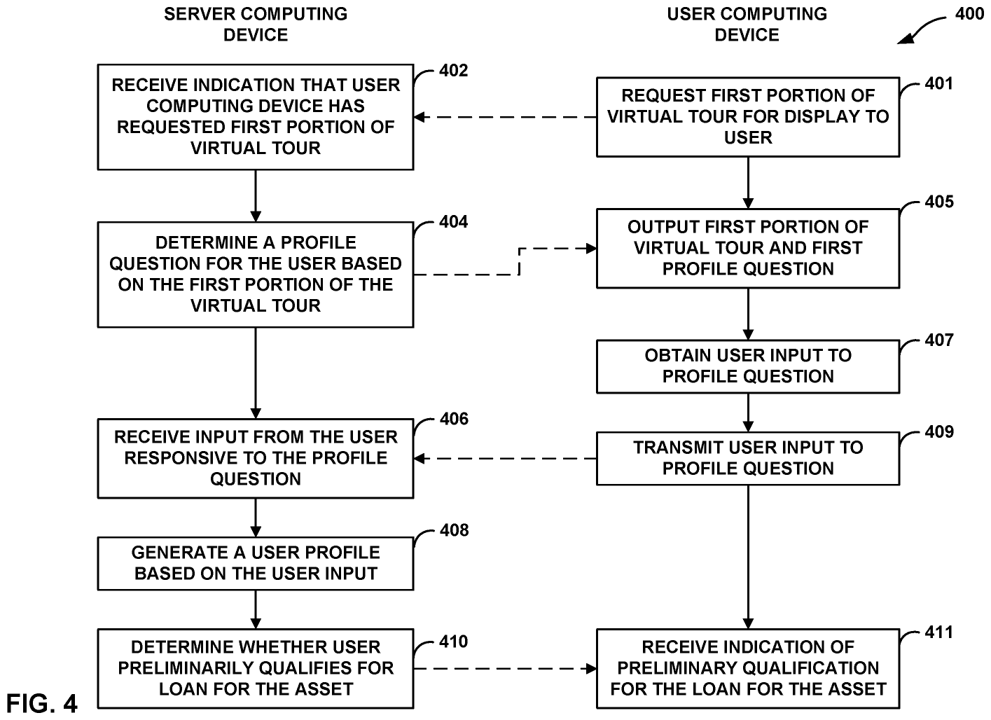

FIG. 4 is a flow diagram illustrating an example operation 400 of computing devices generating leads for loan applications for an asset based on a virtual tour of the asset, in accordance with one or more techniques of this disclosure. For purposes of illustration only, the example operations are described below within the context of server computing device 100 and user computing device 102, as shown in FIGS. 1A-1B and 2.

In the example of FIG. 4, virtual tour unit 110 of user computing device 102 transmits a first request for a first portion of a virtual tour associated with a first view of an asset for display to a user (401). For example, virtual tour unit 110, executed by user computing device 102, transmits the request for portions of the virtual tour to virtual tour generation unit 111, which retrieves the appropriate portions of virtual tour content 224 from storage. In addition, virtual tour generation unit 111, in turn, transmits an indication to lead generation unit 112 that a particular portion of a virtual tour has been requested.

In the example illustrated in FIG. 1A in which virtual tour generation unit 111 is executing on server computing device 100 along with lead generation unit 112, virtual tour generation unit 111 may transmit the indication to lead generation unit 112 using an API or a suitable inter-process communication (IPC) method within server computing device 100. In the example illustrated in FIG. 1B in which virtual tour generation unit 111 is executing on third-party computing device 140 separate from lead generation unit 112 executed on server computing device 100, virtual tour generation unit 111 within third-party computing device 140 may transmit the indication to lead generation unit 112 within server computing device 100 using an API or a communication protocol over network 150.

In either example, virtual tour generation unit 111 may transmit the indication that user computing device 102 has requested the first portion of the virtual tour associated with the asset as an API request for a first profile question and that specifies the first view associated with the first portion of the virtual tour. Example pseudo-code for an API request to lead generation unit 112 from virtual tour generation unit 11 is provided below.
q=LeadGenUnit::getProfileQuestion(propertyID, viewType, userID);

As shown, the API request may include a parameter (e.g., “propertyID”) identifying the particular asset depicted by the virtual tour. The API request may also include a parameter (e.g., “viewType”) specifying the first view associated with the first portion of the virtual tour that was requested by virtual tour unit 110. The API request may further include a parameter (e.g., “userID”) identifying the user of virtual tour unit 110, which can be used to update an existing user profile rather than generate a new user profile based on the request.

Lead generation unit 112 executing on server computing device 100 receives the indication that user computing device 102 has requested the first portion of the virtual tour associated with the first view of the asset for display to the user (402). As discussed above, in some examples, the indication that user computing device 102 has requested the first portion of the virtual tour includes a first parameter specifying the first view associated with the first portion of the virtual tour. For example, lead generation unit 112 may receive an indication that the requested portion of the virtual tour is a view of a first room within the property asset. In this example, the indication for the first portion of the virtual tour may correspond to one or more predetermined room types (e.g., bedroom, garage, kitchen, bathroom, office, etc.).

In response to receiving the indication, lead generation unit 112 may determine the first profile question for the user based on the first portion of the virtual tour (404). In some examples, one of APIs 220 of lead generation unit 112 may select the first profile question from a plurality of predetermined profile questions 226 based on the first parameter specifying the first view associated with the first portion of the virtual tour. Each of the profile questions in the plurality of predetermined profile questions 226 may include at least one tag that maps the question to a view of the asset. In one example, based on the first parameter specifying that the portion of the virtual tour corresponds to a view of a first room within a property, one of APIs 220 of lead generation unit 112 may select a profile question from the plurality of predetermined profile questions 226 that includes a tag corresponding to the room type of the first room (e.g., bedroom, garage, kitchen, bathroom, office, etc.). Profile questions 226 may be configured to allow freeform answers and/or allow answers in the form of one or more pre-determined answer options (i.e., multiple choice).

In some cases, during generation of the virtual tour, an administrator may access lead generation unit 112 via one of APIs 220 and manually assign different profile questions to each portion of the virtual tour associated with a different view of the asset. The administrator may be associated with the lending institution and server computing device 100, or a real estate agency or virtual tour management organization and third-party computing device 140. The administrator may store the assigned profile questions 226 including tags mapping the profile questions to the respective views of the asset in the virtual tour. During operation of the virtual tour, the one of APIs 220 of lead generation unit 112 may select the assigned one of profile questions 226 based on the first parameter specifying the first view of the asset requested by user computing device 102.

In other cases, the profile questions may not be pre-assigned by an administrator, but instead automatically selected in real time by one of APIs 220 based at least on the view of the asset requested by user computing device 102. During operation of the virtual tour, the one of APIs 220 of lead generation unit 112 may select one of profile questions 226 based on the first parameter specifying the first view of the asset requested by user computing device 102. In the case where more than one of profile questions 226 has a tag corresponding to the first view, the one of APIs 220 of lead generation unit 112 may select the one of profile questions 226 based on additional criteria, such as user input from the user responsive to previous profile questions.

Lead generation unit 112 transmits the determined first profile question for integration into the virtual tour. An example of a multiple choice profile question transmitted by lead generation unit 112 is provided below in a JavaScript Object Notation (JSON) format, although other suitable structured and unstructured data formats may be used.

[{

″id″: ″<question_ID>″,
″question″: ″Would this extra room be for an office or for the kids?″,
″options″: [

{″answer_id″:″1″, ″answer_label″:″Office″},
{″answer_id″:″2″, ″answer_label″:″Kids″},
{″answer_id″:″3″, ″answer_label″:″other”,

“answer_type″:”textbox”}

]

}]

In one example, lead generation unit 112 transmits the determined first profile question directly to user computing device 102. In this example, virtual tour unit 110 of user computing device 102 may be configured to integrate the first profile question with the virtual tour content received from virtual tour generation unit 111 included in either server computing device 100 or third-party computing device 140.

In other examples, lead generation unit 112 transmits the determined first profile question to virtual tour generation unit 111 for integration into the virtual tour. In the case illustrated in FIG. 1A where virtual tour generation unit 111 and lead generation unit 112 are both included in server computing device 100, server computing device 100 transmits the determined profile questions packaged together with the requested virtual tour content to user computing device 102. In the case illustrated in FIG. 1B where virtual tour generation unit 111 is included in third-party computing device 140, third-party computing device 140 transmits the determined profile questions packaged together with the requested virtual tour content to user computing device 102.

Upon receipt of the virtual tour content and the first profile question associated with the first portion of the virtual tour, virtual tour unit 110 of user computing device 102 may output the virtual tour content representing the first portion of the virtual tour and the first profile question (405). For example, virtual tour unit 110 may generate GUI 104 for display of the virtual tour to the user via UI device 103. In some examples, virtual tour unit 110 may render the first profile question overlaid on the virtual tour content displayed to the user. In other examples, virtual tour unit 110 may render the first profile question integrated with the virtual tour content upon loading the underlying virtual tour content, once a target time period has elapsed in which the virtual tour content is displayed, or upon detecting a navigation away from the first portion of the virtual tour. For example, virtual tour unit 110 may render the first portion of the virtual tour depicting a bedroom of a property, thereby permitting the user to view the bedroom, and after a target time period, e.g., 20 seconds has elapsed, render the profile question on top of the view of the bedroom.

Virtual tour unit 110 may receive user input from the user in response to the first profile question (407). Virtual tour unit 110 may receive the user input via GUI 104 and/or UI device 103. For example, virtual tour unit 110 may receive a selection of one of the answer choices presented with the profile question (e.g., “Office”) or text input associated with one of the answer choices (e.g., “Other”). Virtual tour unit 110 of user computing device 102 then transmits the user input responsive to the first profile question to lead generation unit 112 of server computing device 100 (409).

Lead generation unit 112 of server computing device 100 receives the user input responsive to the first profile question integrated into the virtual tour of the asset (406). In some examples, one of APIs 220 of lead generation unit 112 may select follow-up profile questions with respect to the first profile question of the virtual tour based on the received user input. For example, lead generation unit 112 may determine a second profile question based on the received user input responsive to the first profile question, and transmit the second profile question for integration into the virtual tour.

Lead generation unit 112 of server computing device 100 generates a user profile 222 based on the received user input (408). For example, user profile 222 may be an entry in an electronic database of the lending institution, and lead generation unit 112 may populate the entry with loan pre-qualification information gathered on the customer based on the user's responses to the profile questions. In some examples, lead generation unit 112 may create the user profile 222 as a new user profile associated with a session of the virtual tour in response to receiving the indication that user computing device 102 requested the first portion of the virtual tour for display to the user. For example, lead generation unit 112 may general a new user profile in real time for each virtual tour visit performed by a user.

In other examples, lead generation unit 112 may can store the user profile 222 such that the same user can be identified during later subsequent visits to the same virtual tour or to other virtual tours provided by virtual tour generation unit 111. For example, during a first session of the virtual tour, lead generation unit 112 may store the user profile 222 based on a network address associated with the user, such as a Media Access Control (MAC) address or Internet Protocol (IP) address of user computing device 102, that requested the first session. During a subsequent session of the virtual tour requested by user computing device 102, lead generation unit 112 may access the stored user profile 222 based on the network address of user computing device 102. Lead generation unit 112 may then update the stored user profile 222 based on responses to one or more profile questions subsequent to the first profile question (e.g., from 404). In other examples, lead generation unit 112 may use other forms of identifiers to tie a user profile to a particular user, including a session identifier or a user identifier.

Lead generation unit 112 determines whether the user is prequalified for a loan for the asset based on the user profile (410). For example, lead generation unit 112 may analyze the loan pre-qualification information pre-populated in user profile 222, and determine whether enough information has been gathered on the customer to make the pre-qualification determination. If enough information is included in user profile 222, lead generation unit 112 may compare the information to certain baseline requirements of the lending institution, e.g., years of employment, education level, estimated annual income, estimate assets, etc. Lead generation unit 112 may then determine that the customer is prequalified for the loan if the customer's information exceeds the baseline requirements.

In some examples, lead generation unit 112 may perform the loan pre-qualification determination in response to detecting that the user has reached an end of the virtual tour or in response to detecting that the user has closed or terminated the virtual tour. In some examples, lead generation unit 112 may perform the loan pre-qualification determination in response to detecting that the user has viewed a threshold amount of the virtual tour (e.g., 80%), which can be used to infer a certain level of interest by the user in the asset. In other examples, lead generation unit 112 may perform the loan pre-qualification in response to an explicit indication, based on user input, that the user is interested in the asset (e.g., clicking a “save this” button). In some examples, lead generation unit 112 may enforce a minimum threshold of user input prior to making the prequalification determination. For example, in response to determining that less than 5 profile questions have been provided and answered, lead generation unit 112 may refrain from determining whether the user prequalifies for a loan due to insufficient information.

In some examples, lead generation unit 112 transmits an indication of whether the user is prequalified for a loan for the asset. The indication may include a request from the lending institution to collect sensitive information from the user to complete processing of the loan. This request may take the form of a link to a secure website and a short application form, or a button with which the user can agree to a telephone call or other secure communication from the lending institution. For example, the behavioral questions integrated into the virtual tour may provide the lending institution with enough information to infer that the user has long-term employment and little debt, but the user's credit score cannot be determined without access to the user's social security number or credit card number. The indication that the user is prequalified for the loan for the asset may be subject to verification of the user's credit score or other sensitive information that a user may not want to provide through a virtual tour website.

Virtual tour unit 110 receives the indication of whether the user is prequalified for the loan for the asset (411). Virtual tour unit 110 modifies GUI 104 based on the received indication of whether the user is prequalified for a loan for the asset. For example, virtual tour unit 110 may modify GUI 104 to overlay the indication that the user is preliminarily qualified for the loan over the final view of the asset displayed as part of the virtual tour.

In other examples, operation 400 may include more or fewer steps. For example, lead generation unit 112 may select additional profile questions, in response to a user's further interaction with a virtual tour (e.g., navigating to other views of the asset and/or answering other profile questions), and use the additional user input to the profile questions for making the determination of whether the user prequalifies for a mortgage loan for the asset. For example, lead generation unit 112 may receive, from user computing device 102, another indication that user computing device 102 has requested a second portion of the virtual tour associated with a second view of the asset for display to the user. One of APIs 220 of lead generation unit 112 may determine a second profile question based on at least one of the second view of the virtual tour (e.g., another room) or the received user input in response to the first profile question (e.g., a follow-up question). Lead generation unit 112 may transmit the second profile question for integration into the virtual tour.

As another example, in the case where the first portion of the virtual tour is related to a first view of a room within a property, lead generation unit 112 may select a profile question that inquiries the user for furnishings intended for the room. Lead generation unit 112 may then generate a lead for purchase of the intended furnishings based on the user input in response to the profile question related to furnishings. Lead generation unit 112, therefore, may simultaneously generate leads for multiple loans and/or sales associated with the asset. For example, lead generation unit 112 may build a user profile based on the received user input in order to determine whether the user is preliminarily qualified for a loan to purchase the asset itself, but may use a subset of the user input responses to generate leads for other purchases related to the asset.

In some examples, example operation 400 may include steps performed in any particular order according to particular needs. As one example, lead generation unit 112 may select a profile question in response to an indication not that a portion of the virtual tour has been requested but rather that the portion of the virtual tour has been retrieved and displayed to a user. As another example, lead generation unit 112 may determine loan prequalification responsive to generating a user profile but may perform the determination at a later point, for example, in response to an indication that the user has completed or ended the virtual tour.

Techniques of this disclosure may provide one or more technical advantages. Online shopping and virtual tours for large ticket assets, e.g., real property or vehicles, are typically managed by merchants or sellers of the assets, and may be separate from lending institutions from which customers may apply for loans for the assets. In some examples, the merchants' or sellers' websites may include links to the websites of one or more lending institutions where the customers may fill out a loan application. The imbedded links, however, can easily be disregarded by customers and typically provide poor results in terms of lead generation for loan applications. In addition, this conventional method requires computing processing and network bandwidth to manage and access at least two separate websites, i.e., to shop for the asset via virtual tours and to apply for a loan to purchase the asset.

The techniques of this disclosure determine questions for integration into different portions of a virtual tour for an asset, and determine whether to pre-qualify the customer for a loan for the asset based on user input responsive to the integrated questions in the virtual tour. The techniques enable behavioral questions to be posed to the customer as part of the virtual tour experience. In this way, the techniques may result in more efficient computing processing, as loan pre-qualification information may be pre-populated in an electronic database of a lending institution such that a customer does not need to enter a different website and/or fill out a traditional loan application.

As an additional technical advantage, generating lead information for loans concurrent with displaying and providing a virtual tour of an asset reduces the amount of computing processing and network traffic otherwise needed for a disparate loan application process, thereby improving the efficiency of the computing devices. The described techniques for providing a virtual tour also allow for more effective lead generation, which may result in a reduction in computing resources that would otherwise be consumed for soliciting the user's attention and response.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software units. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method, comprising:
receiving, by a server computing device, an indication that a user computing device has requested a current session of a virtual tour of an asset;
receiving, by the server computing device and during the current session of the virtual tour displayed on the user computing device, an indication that the user computer device has requested a first portion of the virtual tour associated with a first view of the asset for display on the user computing device, wherein the virtual tour comprises a sequence of graphical content representing different views of the asset;
determining, by the server computing device, a first profile question for integration into the current session of the virtual tour based on the first portion of the virtual tour requested by the user computing device;
rendering, by the server computing device and for display on the user computing device during the current session of the virtual tour, an indication including the first profile question and one or more response option interface elements;
receiving, by the server computing device and based on user input to the one or more response option interface elements received from the user computing device during the current session of the virtual tour, user input responsive to the first profile question integrated into the current session of the virtual tour;
in response to receipt of the user input to the one or more response option interface elements during the current session of the virtual tour, updating, by the server computing device, a user profile based on the received user input, wherein updating the user profile further comprises accessing the user profile based on the network address of the user computing device that requested the current session of the virtual tour, and updating information included in the user profile from previous sessions of the virtual tour based on the user input received during the current session of the virtual tour;
automatically populating, by the server computing device, an entry in an electronic database of a lending institution with at least a portion of the information included in the updated user profile; and
determining, by the server computing device and based on an analysis of the entry in the electronic database of the lending institution, that the user is preliminarily qualified for a loan for the asset.

2. The method of claim 1, further comprising transmitting, by the server computing device and to the user computing device, an indication that the user is preliminarily qualified for the loan for the asset, the indication including a request to collect sensitive information from the user to complete processing of the loan.

3. The method of claim 1, wherein receiving the indication that the user computing device has requested the first portion of the virtual tour comprises receiving the indication from a third-party computing device configured to provide virtual tour content to the user computing device.

4. The method of claim 1,
wherein the indication that the user computing device has requested the first portion of the virtual tour includes a first parameter specifying the first view of the asset associated with the first portion of the virtual tour, and
wherein determining the first profile question for integration into the virtual tour further comprises selecting, by an application programming interface (API) of the server computing device, the first profile question based on the first parameter.

5. The method of claim 4, further comprising selecting, by the API of the server computing device, a second profile question for integration into the virtual tour based on the received user input responsive to the first profile question.

6. The method of claim 4, further comprising:
receiving, by the server computing device, an indication that the user computing device has requested a second portion of the virtual tour associated with a second view of the asset for display to the user, the indication including a second parameter specifying the second view of the asset; and
selecting, by the API of the server computing device, a second profile question for integration into the virtual tour based on at least one of the second parameter or the received user input responsive to the first profile question.

7. The method of claim 1, further comprising:
storing, by the server computing device, a plurality of profile questions that includes the first profile question; and
generating, by the server computing device, a mapping between the plurality of profile questions and the different views of the asset.

8. The method of claim 1, wherein the first profile question inquires the user for additional items intended for use with the asset, the method further comprising generating, by the server computing device and based on the received user input, a lead to a merchant for purchase of the additional items.

9. The method of claim 1, further comprising transmitting, by the server computing device, the determined first profile question for integration into the virtual tour to one of the user computing device or a third-party computing device configured to provide virtual tour content to the user computing device.

10. The method of claim 1, further comprising generating a new user profile for a first session of the virtual tour requested by the user computing device.

11. (canceled)

12. A computing device comprising:
one or more storage units configured to store user profiles and a plurality of profile questions associated with a virtual tour of an asset; and
one or more processors in communication with the storage units and configured to:
receive an indication that a user computing device has requested a current session of the virtual tour of the asset;
receive, during the current session of the virtual tour displayed on the user computing device, an indication that the user computer device has requested a first portion of the virtual tour associated with a first view of the asset for display on the user computing device to a user, wherein the virtual tour comprises a sequence of graphical content representing different views of the asset;
determine a first profile question for integration into the current session of the virtual tour based on the first portion of the virtual tour requested by the user computing device;
render, for display on the user computing device during the current session of the virtual tour, an indication including the first profile question and one or more response option interface elements;
receive, based on user input to the one or more response option interface elements received from the user computing device during the current session of the virtual tour, user input responsive to the first profile question integrated into the current session of the virtual tour;
in response to receipt of the user input to the one or more response option interface elements during the current session of the virtual tour, update a user profile based on the received user input, wherein, to update the user profile, the one or more processors are configured to access the user profile based on the network address of the user computing device that requested the current session of the virtual tour, and update information included in the user profile from previous sessions of the virtual tour based on user input received during the current session of the virtual tour;
automatically populate an entry in an electronic database of a lending institution with at least a portion of the information included in the updated user profile; and
determine, based on an analysis of the entry in the electronic database of the lending institution, that the user is preliminarily qualified for a loan for the asset.

13. The computing device of claim 12, wherein the one or more processors are configured to transmit, to the user computing device, an indication that the user is preliminarily qualified for the loan for the asset, the indication including a request to collect sensitive information from the user to complete processing of the loan.

14. The computing device of claim 12, wherein the one or more processors are configured to receive the indication that the user computing device has requested the first portion of the virtual tour from a third-party computing device configured to provide virtual tour content to the user computing device.

15. The computing device of claim 12, wherein the indication that the user computing device has requested the first portion of the virtual tour includes a first parameter specifying the first view of the asset associated with the first portion of the virtual tour, and wherein the one or more processors are configured to execute an application programming interface (API) to select the first profile question based on the first parameter.

16. The computing device of claim 15, wherein the one or more processors are configured to execute the API to select a second profile question for integration into the virtual tour based on the received user input responsive to the first profile question.

17. The computing device of claim 15, wherein the one or more processors are configured to:
receive an indication that the user computing device has requested a second portion of the virtual tour associated with a second view of the asset for display to the user, the indication including a second parameter specifying the second view of the asset; and
execute the API to select a second profile question for integration into the virtual tour based on at least one of the second parameter or the received user input responsive to the first profile question.

18. The computing device of claim 12, wherein the one or more processors are configured to:
store a plurality of profile questions that includes the first profile question; and
generate a mapping between the plurality of profile questions and the different views of the asset.

19. The computing device of claim 12, wherein the first profile question inquires the user for additional items intended for use with the asset, and wherein the one or more processors are configured to generate a lead to a merchant for purchase of the additional items based on the received user input.

20. The computing device of claim 12, wherein the one or more processors are configured to transmit the determined first profile question for integration into the virtual tour to one of the user computing device or a third-party computing device configured to provide virtual tour content to the user computing device.

21. The computing device of claim 12, wherein the one or more processors are configured to generate a new user profile for a first session of the virtual tour requested by the user computing device.

22. (canceled)

23. A non-transitory computer-readable medium comprising instruction that when executed cause one or more processors to:
receive, by a server computing device, an indication that a user computing device has requested a current session of a virtual tour of an asset;
receive, by the server computing device and during the current session of the virtual tour displayed on the user computing device, an indication that the user computer device has requested a first portion of the virtual tour associated with a first view of the asset for display on the user computing device, wherein the virtual tour comprises a sequence of graphical content representing different views of the asset;
determine, by the server computing device, a first profile question for integration into the current session of the virtual tour based on the first portion of the virtual tour requested by the user computing device;
render, by the server computing device and for display on the user computing device during the current session of the virtual tour, an indication including the first profile question and one or more response option interface elements;
receive, by the server computing device and based on user input to the one or more response option interface elements received from the user computing device during the current session of the virtual tour, user input responsive to the first profile question integrated into the current session of the virtual tour;
in response to receipt of the user input to the one or more response option interface elements during the current session of the virtual tour, update, by the server computing device, a user profile based on the received user input, wherein the instructions that cause the one or more processors to update the user profile further cause the one or more processors to access the user profile based on the network address of the user computing device that requested the current session of the virtual tour, and update information included in the user profile from previous sessions of the virtual tour based on user input received during the current session of the virtual tour;
automatically populate, by the server computing device, an entry in an electronic database of a lending institution with at least a portion of the information included in the updated user profile; and
determine, by the server computing device and based on an analysis of the entry in the electronic database of the lending institution, that the user is preliminarily qualified for a loan for the asset.

24. The method of claim 1, wherein determining that the user is preliminarily qualified for the loan for the asset comprises:
determining whether the portion of the information included in the updated user profile and used to automatically populate the entry in the electronic database of the lending institution is enough to perform a pre-qualification determination;
if enough information is included in the entry in the electronic database of the lending institution, comparing the information included in the entry to one or more baseline requirements of the lending institution; and
if the information included in the entry meets or exceeds the one or more baseline requirements, determining that the user is preliminarily qualified for the loan for the asset.

25. The computing device of claim 12, wherein, to determine that the user is preliminarily qualified for the loan for the asset, the one or more processors are configured to:
determine whether the portion of the information included in the updated user profile and used to automatically populate the entry in the electronic database of the lending institution is enough to perform a pre-qualification determination;
if enough information is included in the entry in the electronic database of the lending institution, compare the information included in the entry to one or more baseline requirements of the lending institution; and
if the information included in the entry meets or exceeds the one or more baseline requirements, determine that the user is preliminarily qualified for the loan for the asset.

26. The method of claim 1 further comprising:
rendering, by the server computing device and for display on the user computing device, the current session of the virtual tour of the asset.

27. The method of claim 1 further comprising:
receiving, from a third party computing device and for display on the user computing device, the current session of the virtual tour of the asset.
